(19) United States
(12) Patent Application Publication
(10) Pub. No.: US 2007/0010989 A1
(43) Pub. Date: Jan. 11, 2007

(54) Decoding procedure for statistical machine translation

(75) Inventors: Tanveer Afzal Faruquie, New Delhi (IN); Hemanta Kumar Maji, Bokaro Steel City (IN); Raghavendra U. Udupa, New Delhi (IN)

Correspondence Address: Frederick W. Gibb, III;McGinn & Gibb, PLLC, Suite 304, 2568-A Riva Road, Annapolis, MD, 21401, US

(73) Assignee: International Business Machines Corporation, Armonk, NY (US)

(21) Appl. No.: 11/176,932

(22) Filed: Jul. 7, 2005

(51) Int. Cl. G06F 17/28

(52) U.S. Cl. 704/2

(57) ABSTRACT

A source sentence is decoded in an iterative manner. At each step a set of partially constructed target sentences are collated, each of which has a score or an associated probability, computed from a language model score and a translation model score. At each iteration, a family of exponentially many alignments is constructed and the optimal translation for this family is found out. To construct the alignment family, a set of transformation operators is employed. The described decoding algorithm is based on the Alternating Optimization framework and employs dynamic programming. Pruning and caching techniques may be used to speed up the decoding.

### FIELD OF THE INVENTION

The invention relates to statistical machine translation, which concerns using statistical techniques to automate translating between natural languages.

### BACKGROUND

The Decoding problem in Statistical Machine Translation (SMT) is as follows: given a French sentence f and probability distributions Pr(e|f) and Pr(e), find the most probable English translation e of f

$$\hat{e} = {arg max}_{e} Pr ( e \vert f ) = {arg max}_{e} Pr ( f \vert e ) Pr ( e ) . \qquad ( 1 )$$

French and English are used as the language pair of convention: the formulation of Equation (1) is applicable to any language pair. This and other background material is established in P. Brown, S. Della Pietra, R. Mercer, 1993, “The mathematics of machine translation: Parameter estimation”, Computational Linguistics, 19(2):263-311. The content of this reference is incorporated herein in its entirety, and is referred to henceforth as Brown et al.

Because of the particular structure of the distribution Pr(f|e) employed in SMT, the above problem can be recast in the following form:

$$( \hat{e} , \hat{a} ) = {arg max}_{e , a} Pr ( f , a \vert e ) Pr ( e ) \qquad ( 2 )$$

where a is a many-to-one mapping from the words of the sentence f to the words of e. Pr (f|e), Pr(e), and a are in SMT parlance known as Translation Model, Language Model, and alignment respectively.

Several solutions exist for the decoding problem. The original solution to the decoding problem employed a restricted stack-based search, as described in U.S. Pat. No. 5,510,981 issued Apr. 23, 1996 to Berger et al. This approach takes exponential time in the worst case. An adaptation of the Held-Karp dynamic programming based TSP algorithm to the decoding problem runs in O(l³m⁴)≈O(m⁷) time (where m and l are the lengths of the sentence and its translation respectively) under certain assumptions. For small sentence lengths, optimal solution to the decoding problem can be found using either the A* heuristic or integer linear programming. The fastest existing decoding algorithm employs a greedy decoding strategy and finds suboptimal solution in O(m⁶) time. A more complex greedy decoding algorithm finds suboptimal solution in O(m²) time. Both algorithms are described in U. Germann, “Greedy decoding for statistical machine translation in almost linear time”, Proceedings of HLT-NAACL 2003, Edmonton, Canada.

An algorithmic framework for solving the decoding problem is described in Udupa et al., full publication details for which are: R. Udupa, T. Faruquie, H. Maji, “An algorithmic framework for the decoding problem in statistical machine translation”, Proceedings of COLING 2004, Geneva, Switzerland. The content of this reference is incorporated herein in its entirety. The substance of this reference is also described in U.S. patent application Ser. No. 10/890,496 filed 13 Jul., 2004 in the names of Raghavendra U Udupa and Tanveer A Faruquie, and assigned to International Business Machines Corporation (IBM Docket No JP9200300228US1). The content of this reference is also incorporated herein in its entirety.

The framework described in the above references is referred to as alternating optimization, in which the decoding problem of translating a source sentence to a target sentence can be divided into two sub-problems, each of which can be solved efficiently and combined to iteratively refine the solution. The first sub-problem finds an alignment between a given source sentence and a target sentence. The second sub-problem finds an optimal target sentence for a given alignment and source sentence. The final solution is obtained by alternatively solving these two sub-problems, such that the solution of one sub-problem is used as the input to the other sub-problem. This approach provides computational benefits not available with some other approaches.

As is apparent from the foregoing description, a decoding algorithm is assessed in terms of speed and accuracy. Improved speed and accuracy relative to competing systems is desirable for the system to be useful in a variety of applications. The speed of the decoding algorithm is primarily responsible for its usage in real-time translation applications, such as web pages translation, bulk document translations, real-time speech to speech systems and so on. Accuracy is more highly valued in applications that require high quality translations but do not require real-time results, such as translations of government documents and technical manuals.

Though progressive improvements have been made in solving the decoding problem, some of which are described above, further improvements—such as in speed and accuracy—are clearly desirable.

### SUMMARY

A decoding system takes a source text and from a language model and a translation model generates a set of target sentences and associated scores, which represent the probability for the generated particular target sentence. The sentence with the highest probability is the best translation for the given source sentence.

The source sentence is decoded in an iterative manner. In each of the iterations, two problems are solved. First, an alignment family consisting of exponentially many alignments is constructed and the optimal translation for this family of alignments is found out. To construct the alignment family, a set of alignment transformation operators is employed. These operators are applied on a starting alignment, also called the generator alignment, systematically. Second, the optimal alignment between the source sentence and the solution obtained in the previous step is computed. This alignment is used as the starting alignment for the next iteration.

The described decoding procedure uses the Alternating Optimization framework described in above-mentioned U.S. patent application Ser. No. 10/890,496 filed 13 Jul. 2004 and uses dynamic programming. The time complexity of the procedure is O(m²), where m is the length of the sentence to be translated.

An advantage of the decoding procedure described herein is that the decoding procedure builds a large sub-space of the search space, and uses computationally efficient methods to find a solution in this sub-space. This is achieved by proposing an effective solution to solve a first sub-problem of the alternating optimization search. Each alternating iteration builds and searches many such search sub-spaces. Pruning and caching techniques are used to speed up this search.

The decoding procedure solves the first sub-problem by first building a family of alignments with an exponential number of alignments. This family of alignment represents a sub-space within the search space. Four operations: COPY, GROW, MERGE and SHRINK are used to build this family of alignments. Dynamic programming techniques are then used to find the “best” translation within this family of alignments, in m phases, in which m is the length of source sentence. Each phase maintains a set of partial hypotheses which are extended in subsequent phases using one of the four operators mentioned above. At the end of m phases the hypothesis with the best score is reported.

The reported hypothesis is the optimal translation which is then used as the input to the second sub-problem of the alternating optimization search. When the first sub-problem of finding optimal translation is again revisited in the next iteration, a new family of alignments is explored. The optimal translation (and its associated alignment) found in the last iteration is used as a foundation to find the best swap of “tablets” that improves the score of previous alignment. This new alignment is then taken as the generator alignment and a new family of alignments can be build using the operators.

The algorithm uses pruning and caching to speed performance. Though any pruning method can be used, generator guided pruning is a new pruning technique described herein. Similarly, any of the parameters can be cached, and the caching of language model and distortion probabilities improves performance.

As the search space explored by the procedure is large, two pruning techniques are used. Empirical results obtained by extensive experimentation on test data show that the new algorithm's runtime grows only linearly with m when either of the pruning techniques is employed. The described procedure outperforms existing decoding algorithms and a comparative experimental study shows that an implementation 10 times faster than the implementation of the Greedy decoding algorithm can be achieved.

### DESCRIPTION OF DRAWINGS

One or more embodiments of the invention will now be described with reference to the following drawings.

FIG. 1 is a schematic representation of an alignment a for the sentence pair f, e.

FIG. 2 is a schematic representation of an example tableau and permutation.

FIG. 3 is a schematic representation of alignment transformation operations.

FIG. 4 is a schematic representation of a partial hypothesis expansion.

FIG. 5 is a flow chart of steps that describe how to compute the optimal alignment starting with a generator alignment.

FIG. 6 is a flow chart of steps that describe a hypothesis extension step in which various operators are used to extend a target hypothesis.

FIG. 7 is a flow chart of steps described how in each iteration a new generator alignment is selected.

FIG. 8 is a schematic representation of a computer system of a type suitable for executing the algorithmic operations described herein.

FIGS. 9 to 24 present various experimental results, as briefly outlined below and subsequently described in context.

FIG. 9 is a graph depicting the effect of percentage of hypotheses retained by pruning with a geometric mean.

FIG. 10 is a graph depicting the percentage of partial hypotheses retained by the Generator Guided Pruning (GGP) technique.

FIG. 11 is a graph depicting the effect of pruning against time with Geometric Mean (PGM), Generator Guided Pruning (GGP) and Fixed Alignment Decoding (FAD).

FIG. 12 is a graph comparing average hypothesis logscores of Geometric Mean (PGM) and Generator Guided Pruning (GGP).

FIG. 13 is a graph depicting the effect of pruning with Geometric Mean (PGM) and no pruning against time.

FIG. 14 is a graph depicting trigram caching accesses for first hits, subsequent hits and total hits.

FIG. 15 is a graph depicting the time taken by Generator Guided Pruning (GGP) with: (a) no caching, (b) Distortion Caching, (c) Trigram Caching, (d) Distortion and Trigram Caching.

FIG. 16 is a graph depicting the number of distortion model caching accesses for first hits, subsequent hits and total hits.

FIG. 17 is a graph depicting the time used by different combinations of alignment transformation operations for: (a) all operations but the GROW operation, (b) all operations but the SHRINK operation, (c) all operations but the MERGE operation, and (d) all operations.

FIG. 18 is a graph depicting the effect of different combinations of alignment transformation operations on logscores for: (a) all operations but the GROW operation, (b) all operations but the SHRINK operation, (c) all operations but the MERGE operation, and (d) all operations.

FIG. 19 is a graph depicting the time taken by the iterative search algorithm with Generator Guided Pruning (IGGP), compared with Generator Guided Pruning (GGP) without the iterative search algorithm.

FIG. 20 is a graph depicting the logscores of the iterative search algorithm with Generator Guided Pruning (IGGP) depicted in FIG. 15, compared with Generator Guided Pruning (GGP) without the iterative search algorithm.

FIG. 21 is a graph depicting the time taken by the iterative search algorithm with pruning with Geometric Mean (IPGM), compared with pruning with Geometric Mean (PGM) without the iterative search algorithm.

FIG. 22 is a graph depicting the logscores of the iterative search algorithm with pruning with Geometric Mean (IPGM) depicted in FIG. 17, compared with pruning with Geometric Mean (PGM) without the iterative search algorithm.

FIG. 23 is a graph comparing the time taken by the iterative search algorithm both with Generator Guided Pruning (IGGP) and pruning with Geometric Mean (IPGM) with the Greedy Decoder.

FIG. 24 is a graph comparing the logscores for the iterative search algorithm with Generator Guided Pruning (IGGP) and pruning with Geometric Mean (IPGM), and the Greedy Decoder.

### DETAILED DESCRIPTION

### 1 Introduction

Decoding is one of the three fundamental problems in SMT and the only discrete optimization problem of the three. The problem is NP-hard even in the simplest setting. In applications such as speech-to-speech translation and automatic webpage translation, the translation system is expected to have a very good throughput. In other words, the Decoder should generate reasonably good translations in a very short duration of time. A primary goal is to develop a fast decoding algorithm which produces satisfactory translations.

An O(m²) algorithm in the alternating optimization framework is described (Section 2.3). The key idea is to construct a reasonably big subspace of the search space of the problem and design a computationally efficient search scheme for finding the best solution in the subspace. A family of alignments (with Θ (4^{m}) alignments) is constructed starting with any alignment (Section 3). Four alignment transformation operations are used to build a family of alignments from the initial alignment (section 3.1).

A dynamic programming algorithm is used to find the optimal solution for the decoding problem within the family of alignments thus constructed (Section 3.3). Although the number of alignments in the subspace is exponential in m, the dynamic algorithm is able to compute the optimal solution in O(m²) time. The algorithm is extended to explore several such families of alignments iteratively (Section 3.4). Heuristics can be used to speedup the search (Section 3.5). By caching some of the data used in the computations, the speed is further improved (Section 3.6).

### 2 The Decoding Problem

2.1 Preliminaries

Let f and e denote a French sentence and an English sentence respectively. Suppose f has m>0 words and e has 1>0 words. These respective sentences can be represented as f=f₁f₂ . . . fₘ and e=e₁e₂ . . . e₁, where fⱼ and eᵢ respectively denote the jth and ith word in the French or English sentence. For technical reasons, the null word e₀ is prepended to every English sentence. The null word is necessary to account for French words that are not associated with any of the words in e.

An alignment, a, is a mapping which associates each word fⱼ; j=1, . . . m in the French sentence (f) to some word eₐ_{ⱼ}; aⱼε {0, . . . , 1} in the English sentence e. Equivalently, a is a many-to-one mapping from the words of f to the word positions 0, . . . l in e. The alignment a can be represented as a=a₁a₂ . . . aₘ with the meaning fⱼ mapped to eₐ_{ⱼ}.

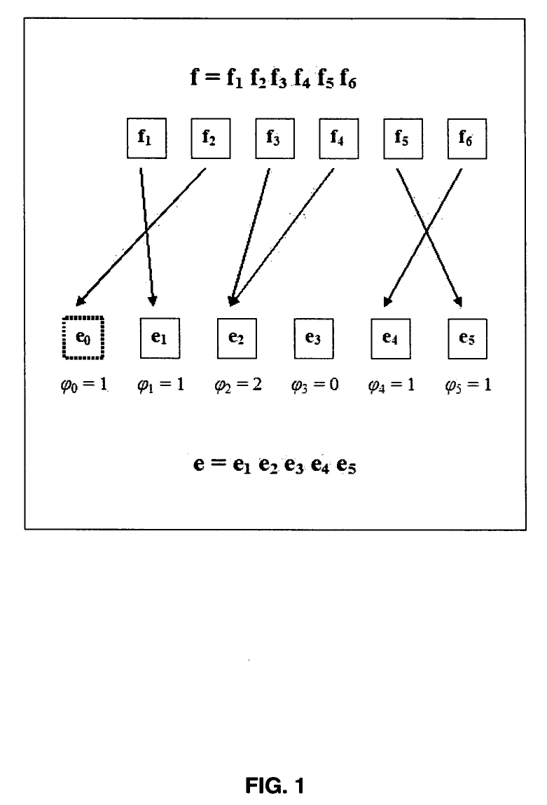

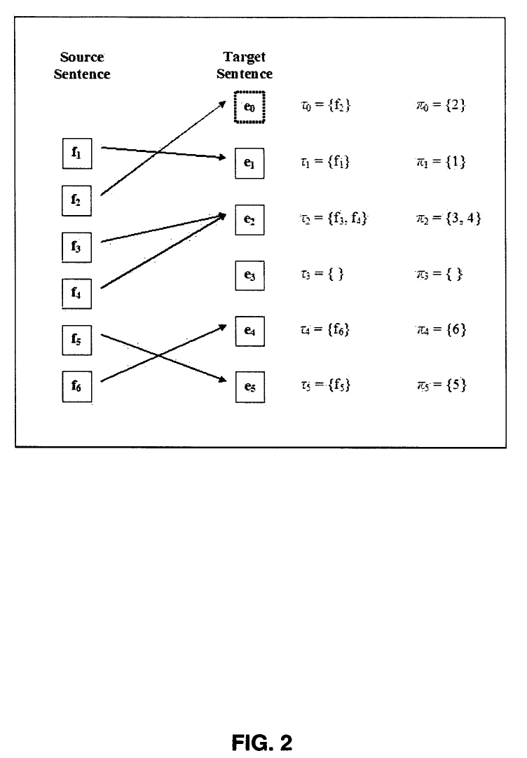

FIG. 1 shows an alignment a for the sentence pair f, e. This particular alignment associates f₁ with e₁ (that is, a₁=1) and f₂ with e₀ (that is, a₂=0). Note that f₃ and f₄ are mapped to e₂ by a.

The fertility of eᵢ, i=0, . . . l in an alignment a is the number of words of f mapped to it by a. Let Øᵢ denote the fertility of eᵢ, i=0, . . . l. In the alignment shown in FIG. 1, the fertility of e₂ is 2 as f₃ and f₄ are mapped to it by the alignment while the fertility of e₃ is 0. A word with non-zero fertility is called a fertile word and a word with zero fertility is called a infertile word. The maximum fertility of an English word is denoted by Øₘₐₓ and is typically a small constant.

Associated with every alignment are a tableau and a permutation. Tableau is a partition of the words in the sentence f induced by the alignment and permutation is an ordering of the words in the partition.

2.1.1 Tableau

Let τ be a mapping from [0, . . . l] to subsets of {f₁, . . . fₘ} defined as follows:
τᵢ={fᵢ:jε{1, . . . ,m}∀aⱼ=i}∀i=0, . . . ,l
τᵢ is the set of French words which are mapped to the word position i in the translation by the alignment. τᵢ, i=0, . . . l are called the tablets induced by the alignment a and τ is called a tableau. The kth word in the tablet τᵢ is denoted by τᵢₖ.
2.1.2 Permutation

Let permutation π be a mapping from [0, . . . l] to subsets of {1, . . . ,m} defined as follows:
πᵢ={j:jε{1, . . . ,m}∀aⱼ=i}∀i=0, . . . ,l.
πᵢ is the set of positions that are mapped to position i by the alignment a. The fertility of eᵢ is Øᵢ=|πᵢ|. Assume that the positions in the set 7 is are ordered, i.e. πᵢₖ<πᵢₖ₊1, k=1, . . . ,Øᵢ−1. Further assume that τᵢₖ=f_{π}_{ᵢₖ}∀i=0, . . . , l∀k=1, . . . , φᵢ.

There is a unique alignment corresponding to a tableau and a permutation.

2.2 Probability Models

Every English sentence e is a “translation” of f, though some translations are more likely than others. The probability of e is Pr(e|f). In SMT literature, the distribution Pr (e|f) is replaced by the product Pr(f|e) Pr(e) (by applying Bayes' rule) for technical reasons. Furthermore, a hidden alignment is assumed to exist for each pair (f,e) with a probability Pr(f,a|e) and the translation model (Pr(f|e)) is expressed as a sum of Pr(f,a|e) over all alignments: Pr(f|e)=Σₐ Pr (f,a|e).

Pr(f,a|e) and Pr(e) are modeled using models that work at the level of words. Brown et al. propose a set of 5 translation models, commonly known as IBM 1-5. IBM-4 along with the trigram language model is known in practice to give better translations than other models. Therefore, decoding algorithm is described in the context of IBM-4 and trigram language model only, although the described methods can be applied to other IBM models as well.

2.2.1 Factorization of Models

While IBM 1-5 models can be factorized in many ways, a factorization which is useful in solving the decoding problem efficiently is used. The factorization is along the words of the translation:

$$Pr ( f , a \vert e ) = {\prod }_{i = 0}^{l} {𝒯}_{i} {𝒟}_{i} {𝒩}_{i} , \\ Pr ( e ) = {\prod }_{i = 0}^{l} {ℒ}_{i} ,$$

and therefore

$$Pr ( f , a \vert e ) Pr ( e ) = {\prod }_{i = 0}^{l} {𝒯}_{i} {𝒟}_{i} {𝒩}_{i} {ℒ}_{i} .$$

Here, the terms Tᵢ, Dᵢ, Nᵢ, and Lᵢ are associated with eᵢ. The terms Tᵢ, Dᵢ, Nᵢ are determined by the tableau and the permutation induced by the alignment. Only Lᵢ is Markovian.

IBM-4 employs distributions to (word translation model), n( ) (fertility model), d₁( ) (head distortion model) and d_{>1}( ) (non-head distortion model) and the language model employs the distribution tri( ) (trigram model).

For IBM-4 and trigram language model:

$${𝒯}_{i} = {\prod }_{k = 1}^{{ϕ}_{i}} t ( {τ}_{ik} \vert {e}_{i} )$$

$${𝒩}_{i} = \{ \begin{matrix}{n}_{o} ( {ϕ}_{o} \vert {\sum }_{i = 1}^{l} {ϕ}_{i} ) & if i = 0 \\ {ϕ}_{i} ! n ( {ϕ}_{i} \vert {e}_{i} ) & if 1 \leq i \leq l\end{matrix} \\ {𝒟}_{i} \{ \begin{matrix}1 & if i = 0 \\ {\prod }_{k = 1}^{{ϕ}_{i}} Pik ( {π}_{ik} ) & if 1 \leq i \leq l\end{matrix} \\ {ℒ}_{i} = \{ \begin{matrix}1 & if i = 0 \\ tri ( {e}_{i} \vert {e}_{i - 2} {e}_{i - 1 )} & if 1 \leq i \leq l\end{matrix} \\ where , \\ {n}_{0} ( {ϕ}_{0} \vert {m}^{′} ) = ( \begin{matrix}{m}^{′} \\ {ϕ}_{0}\end{matrix} ) {P}_{0}^{{m}^{′} - {ϕ}_{0}} {P}_{1}^{{ϕ}_{0}} \\ {P}_{ik} = \{ \begin{matrix}{d}_{1} ( j - {c}_{pi} \vert 𝒜 ( {e}_{pi} ) , {ℬ}_{( {T}_{ik} )} ) & if k = 1 \\ {d}_{> 1} ( j - {π}_{ik - 1} \vert ℬ ( {T}_{ik )} ) & if k > 1\end{matrix} \\ {ρ}_{i} = {max}_{{i}^{′} < i} \{ {i}^{′} : {ϕ}_{{i}^{′}} > 0 \} \\ {c}_{ρ} = ⌈ \frac{1}{{ϕ}_{ρ}} {\sum }_{k = 1}^{{ϕ}_{ρ}} {π}_{ρ k} ⌉ .$$

A and B are word classes, ρᵢ is the previous fertile English word, c_{ρ} is the center of the French words connected to the English word e_{ρ}, ρ₁ is the probability of connecting a French word to the null word (e₀), and ρ₀=1−ρ₁.

Although IBM-4 is a complex model, factorization to T, D, N and L can be used, as described herein, to design an efficient decoding algorithm.

2.3 Alternating Optimization Framework

The decoder attempts to solve the following search problem:

$$( \hat{e} , \hat{a} ) = {arg max}_{e , a} Pr ( f , a \vert e ) Pr ( e )$$

where Pr(f, a|e) and Pr(e) are defined as described in the previous section.

In the alternating optimization framework, instead of joint optimization, one alternates between optimizing e and a:

$$\begin{matrix}\hat{e} = {arg max}_{e} Pr ( f , a \vert e ) Pr ( e ) & ( 3 ) \\ \hat{a} = {arg max}_{a} Pr ( f , a \vert e ) Pr ( e ) & ( 4 )\end{matrix}$$

In the search problem specified by Equation (3), the length of the translation (1) and the alignment (a) is kept fixed while in the search problem specified by Equation (4), the translation (e) is kept fixed. An initial alignment is used as a basis for finding the best translation for f with that alignment. Next, keeping the translation fixed a new alignment is determined which is at least as good as the previous one. Both the alignment and the translation are iteratively refined in this manner. The framework does not require that the two problems be solved exactly. Suboptimal solutions to the two problems in every iteration are sufficient for the algorithm to make progress.

Alternating optimization framework is useful in designing fast decoding algorithms for the following reason:

Lemma 1. Fixed Alignment Decoding: The solution to the search problem specified by Equation 3 can be found in O(m) time by Dynamic Programming.

A suboptimal solution to the search problem specified by Equation (4) can be computed in O(m) by local search. Further details concerning this proposition can be obtained from Udupa et al., referenced above and incorporated herein in its entirety.

### 3 Searching a Family of Alignments

A family of alignments starting with any alignment can be constructed.

3.1 Alignment Transformation Operations

Let a, a′ be any two alignments. Let (τ,π) and (τ′,π′) be the tableau and permutation induced by a and a′ respectively. A relation R is defined between alignments and say that a′Ra if a′ can be derived from a by doing one of the operations COPY, GROW, SHRINK and MERGE on each of (τᵢ,πᵢ), 0≦i≦1 starting with (τ₁,π₁). Let i and i′ be the counters for (τ,π) and (τ′,π′) respectively. Initially, (τ₀,π₀)=(τ₀,π₀) and i′=i=1. The operations are as follows:

1. Copy:
(τ′_{i′},π′_{i′})=(τᵢ,πᵢ);
i=i+1;i′=i′+1.
2. Grow:
(τ′_{i′},τ′_{i′})=({},{})
(τ′_{i′+1},π′_{i′+1})=(τᵢ,πᵢ);
i=i+1;i′=i′+2.
3. Shrink:
(τ′₀,π′₀)=(τ′₀∪tᵢ,π′₀∪πᵢ);
i=i+1.
4. Merge:
(τ′_{i′-1},π′_{i′-1})=(τ′_{i′-1}∪τᵢ,π′_{i′-1}∪πᵢ);
i=i+1

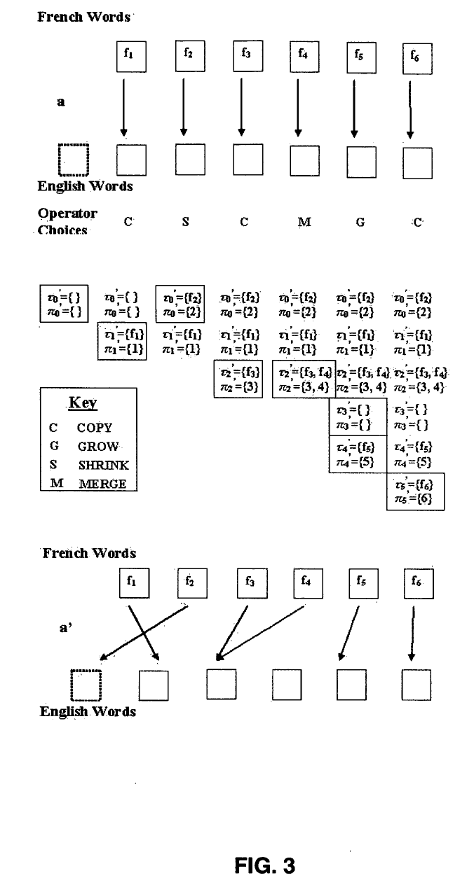

FIG. 3 illustrates the alignment transformation operations on an alignment and the resulting alignment.

The four alignment transformation operations generate alignments that are related to the starting alignment but have some structural difference. The COPY operations maintain structural similarity in some parts between the starting alignment and the new alignment. The GROW operations increase the size of the alignment and therefore, the length of the translation. The SHRINK operations reduce the size of the alignment and therefore, the length of the translation. MERGE operations increase the fertility of words.

3.2 A Family of Alignments

Given an alignment a, the relation R defines the following family of alignments: A={a′:a′Ra}. Further, if a is one-to-one, the size of this family of alignments is |A|=Θ(4^{m}) and a is called the generator of the family A.

A family of alignments A, is determined and the optimal solution in this family is computed:

$$( \hat{e} , \hat{a} ) = {arg max}_{e , a ∈ A} Pr ( f , a \vert e ) Pr ( e ) \qquad ( 5 )$$

3.3 A Dynamic Programming Algorithm

Computing the optimal solution in a family of alignments is now described.

Lemma 2. The solution to the search problem specified by Equation 5 can be computed in O(m²) time by Dynamic Programming when A is a family of alignments as defined in Section 3.2.

The dynamic programming algorithm builds a set of hypotheses and reports the hypothesis with the best score and the corresponding translation, tableau and permutation. The algorithm works in m phases and in each phase it constructs a set of partial hypotheses by expanding the partial hypotheses from the previous phase. A partial hypothesis after the ith phase, h, is a tuple (e₀ . . . e′_{i′}, τ′₀ . . . τ′_{i′},π′₀ . . . π′_{i′},C) where e₀ . . . e_{e′} is the partial translation, τ′₀ . . . τ′_{i′} the partial tableau, π′₀ . . . π′_{i′} is the partial permutation, and C is the score of the partial hypothesis.

In the beginning of the first phase, there is only one partial hypothesis (e₀,τ′₀,π′₀,0). In the ith phase, a hypothesis is extended as follows:

1. Do an alignment transformation operation on the pair (τᵢ,πᵢ)

2. For each pair (π′_{i′},π′_{i′}) added by doing the operation

(a) Choose a word e_{i′} from the English vocabulary.
(b) Include e_{i′} and (τ′_{i′},π′_{i′}) in the partial hypothesis.

### 3. Update the Score of the Hypothesis

As observed in Section 3.2, an alignment transformation operation can result in the addition of 0 or 1 or 2 new tablets. Since each tablet corresponds to an English word, the expansion of a partial hypothesis results in appending 0 or 1 or 2 new words to the partial sentence:

1. COPY: An English word e_{i′} is appended to the partial translation (i.e. the partial translation grows from e₀ . . . e_{i′-1} to e₀ . . . e_{i′}). The word e_{i′} is chosen from the set of candidate translations of the French words in the tablet τᵢ. If the number of candidate translations a French word can have in the English vocabulary is bounded by N_{F}, then the number of new partial hypotheses resulting from the COPY operation is at most N_{F}.

2. GROW: Two English words e_{i′},e_{i′+}1 are appended to the partial translation as a result of which the partial translation grows from e₀ . . . e_{i′-1} to e₀ . . . e_{i′}e_{i′+1}. The word e_{i′} is chosen from the set of infertile English words and e_{i′+1} from the set of English translations of the French words in the tablet τᵢ. If the number of infertile words in the English vocabulary is N₀, then the number of new partial hypotheses resulting from the GROW operation is at most N_{F}N₀.

3. SHRINK, MERGE: The partial translation remains unchanged. Only one new partial hypothesis is generated.

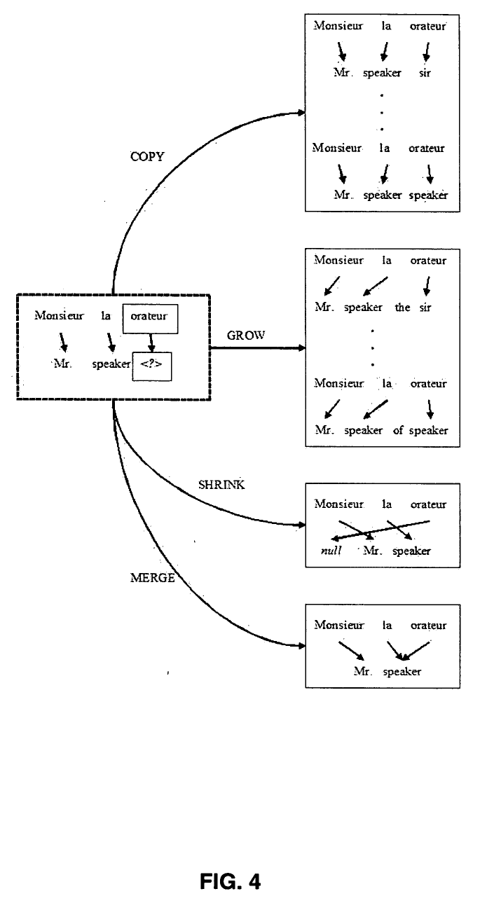

FIG. 4 illustrates the expansion of a partial hypothesis using the alignment transformation operations.

At the end of a phase of expansion, these are a set of partial hypotheses. These hypotheses can be classified based on the following:

1. The last two words in the partial translation (e_{i′-1}, e_{i′}),

2. Fertility of the last word in the partial translation (|π′_{i′}|) and

3. The center of the tablet corresponding to the last word in the partial translation.

If two partial hypotheses in the same class are extended using the same operation, then their scores increase by equal amount. Therefore, for each class of hypotheses the algorithm retains only the one with the highest score.

3.3.1 Analysis

The algorithm has m phases and in each phase a set of partial hypotheses are expanded. The number of partial hypotheses generated in any phase is bounded by the product of the number of hypothesis classes in that phase and the number of partial hypotheses yielded by the alignment transformation operations. The number of partial hypotheses classes in phase i is determined. There are at most |V_{E}|² choices for (e_{i′-1}, e_{i′}), at most φₘₐₓ choices for the fertility of e_{i′} and m choices for the center of the tablet corresponding to e_{i′}. Therefore, the number of partial hypotheses classes in phase i is at most φₘₐₓ|V_{E}|² m. The alignment transformation operations on a partial hypothesis result in at most N_{F} (1+N₀)+2 new partial hypotheses. Therefore, the number of partial hypotheses generated in phase i is at most φₘₐₓ (N_{F}(1+N₀)+2)|V_{E}|² m. As there are totally m phases, the total number of partial hypotheses generated by the algorithm is at most φₘₐₓ (N_{F}(1+N₀)+2) |V_{E}|²m². Note that φₘₐₓ, N_{F} and N₀ are constants independent of the length of the French sentence. Therefore, the number of operations in the algorithm is O(m²). In practice φₘₐₓ<10, N_{F}≦11, and N₀≦100.

3.4 Iterative Search Algorithm

Several alignment families are explored iteratively using the alternating optimization framework. In each iteration two problems are solved. In the first problem, a generator alignment a is used as a reference to build an alignment family A for the generator. The best solution in that family is determined using the dynamic programming algorithm. In the second problem, a new generator is determined for the next iteration. To find a new generator, the tablets in the solution found in the previous step are swapped, and checked if that improves the score. In fact, the best swap of tablets that improves the score of the solution is thus determined. Clearly, the resulting alignment ã is not part of the alignment family A. This alignment ã is used as the generator in the next iteration.

3.5 Pruning

Although our dynamic programming algorithm takes O(m²) time to compute the translation, the constant in the O is prohibitively large. In practice, the number of partial hypotheses generated by the algorithm is substantially smaller than the bound in Section 3.3.1, but large enough to make the algorithm slow. Two partial hypothesis pruning schemes are described below, which are helpful in speeding up the algorithm.
3.5.1 Pruning with the Geometric Mean

At each phase of the algorithm, the geometric mean of the scores of partial hypotheses generated in that phase is computed. Only those partial hypotheses whose scores are at least as good as the geometric mean are retained for the next phase and the rest are discarded. Although conceptually simple, pruning the partial hypotheses with the Geometric Mean as the cutoff is a efficient pruning scheme as demonstrated by empirical results.

3.5.2 Generator Guided Pruning

In this scheme, the generator of the alignment family A is used to find the best translation (and tableau and permutation) using the O(m) algorithm for Fixed Alignment Decoding. We then determine the score C⁽ⁱ⁾, at each of the m phases, of the hypothesis that generated the optimal solution. These scores are used to prune the partial hypotheses of the dynamic programming algorithm. In the ith phase of the algorithm, only those partial hypotheses whose scores are at least C⁽ⁱ⁾ are retained for the next phase and the rest are discarded. This pruning strategy incurs the overhead of running the algorithm for Fixed Alignment Decoding for the computation of the cutoff scores. However, this overhead is insignificant in practice.

3.6 Caching

The probability distributions (n,d₁,d_{>},t and tri) are loaded into memory by the algorithm before decoding. However, it is better to cache the most frequently used data in smaller data structures so that subsequent accesses are relatively faster.

3.6.1 Caching of Language Model

While decoding the French sentence, one knows a priori the set of all trigrams that could potentially be accessed by the algorithm. This is because these trigrams are formed by the set of all candidate English translations of the French words in the sentence and the set of infertile words. Therefore, a unique id can be assigned for every such trigram. When the trigram is accessed for the first time, it is stored in an array indexed by its id. Subsequent accesses to the trigram make use of the cached value.

3.6.2 Caching of Distortion Model

As with the language model, the actual number of distortion probability data values accessed by the decoder while translating a sentence is relatively small compared to the total number of distortion probability data values. Further, distortion probabilities are not dependent on the French words but on the position of the words in the French sentence. Therefore, while translating a batch of sentences of roughly the same length, the same set of data is accessed repeatedly. The distortion probabilities required by the algorithm are cached.

3.6.3 Starting Generator Alignment

The algorithm requires a starting alignment to serve as the generator for the family of alignments. The alignment aⱼ=j, i.e., l=m and a=(1, . . . ,m) is used as the starting alignment.

### 4 Overview

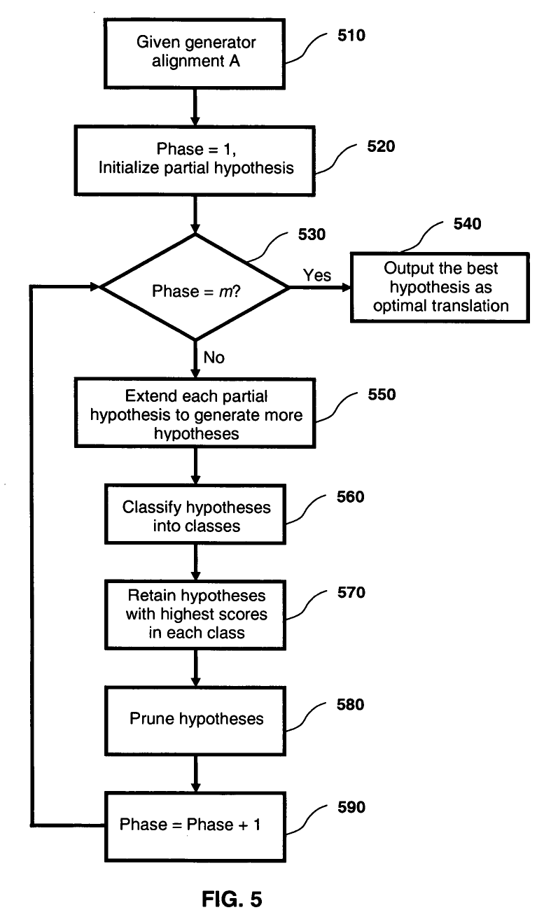

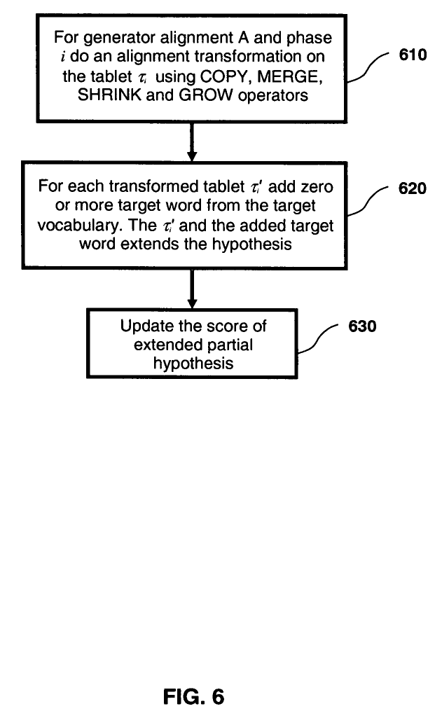

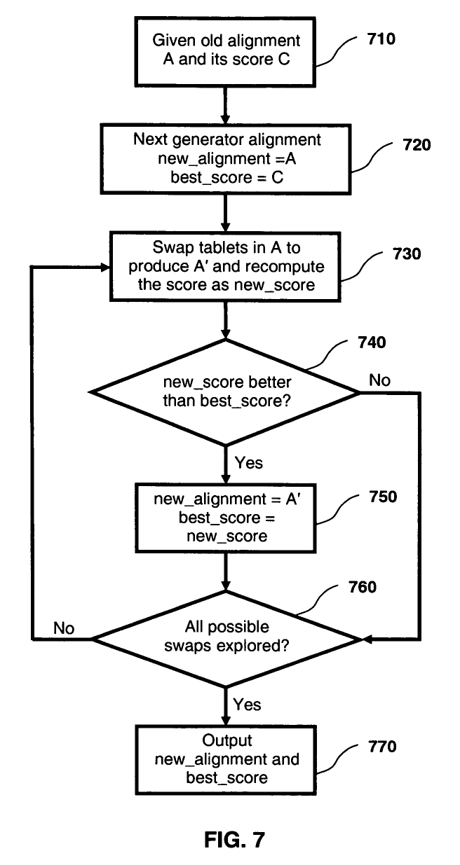

This Section describes an overview of the procedures involved in determining optimal alignments. The following flowcharts are used to describe the procedure. FIG. 5 flow charts how to build a family of alignments using the generator alignment and find the optimal translation within this family. FIG. 6 flow charts in more detail the hypothesis extension step of FIG. 5, in which various operators are used to extend the hypothesis (and thus extend the search space). FIG. 7 flow charts how, in each iteration, a new generator alignment is selected. Thus, the methods of FIGS. 5, 6 and 7 are performed in each iteration. The procedure described by FIG. 5 starts with a given generator alignment A in step 510. Phase is initialized to one, and the partial target hypothesis is also initialized in step 520. A check is made of whether or not phase is equal to m, in step 530. If phase is equal to m, then all phases are completed, and the best hypothesis is output as the optimal translation in step 540. Otherwise, if the phase is yet to equal m, each partial hypothesis is extended to generate further hypotheses in step 550. The generated hypotheses are classified into classes in step 560, and the hypotheses with the highest scores are retained in each class in step 570. The hypotheses are pruned in step 580. The phase is incremented in step 590, after which processing returns to step 530, described above, in which a check is made of the phase to determine whether a further phase is performed.

The procedure described by FIG. 6 for extending a hypothesis is a series of steps 610, 620 and 630. Collectively, these steps correspond to step 550. An alignment transformation is performed in step 610 for an alignment A and phase i on a tablet τᵢ using operators of COPY, MERGE, SHRINK and GROW. Zero or more target words are added from a target vocabulary in step 620 for each transformed tablet ττᵢ′ generated in step 610. The transformed tablet τᵢ′ and the added target words extend the hypothesis. Finally, in step 630, the score of the partial hypothesis extended in step 620 is updated.

The procedure described by FIG. 7 for selecting a new generator alignment starts with an old alignment A and its corresponding score C in step 710. The next generator alignment (new-alignment) is initialized to this old alignment A, and the corresponding score is recorded as the best score (best_score) in step 720. Tablets in alignment A are swapped to produce a modified alignment A′, the score is accordingly recomputed and recorded as new_score in step 730. A determination is made in step 740 of whether or not the score for the modified alignment A′ is better score than that of the score for the old alignment A. That is, a computation is made of whether new_score is greater than best_score. If the modified alignment A′ does have a better score than that of the score for the old alignment A, then in step 750, the new-alignment is recorded as the modified alignment A′, and the best_score is updated to be the new_score associated with the modified alignment A′. Following this step 750, or if the modified alignment A′ does not have a better score than that of the old alignment A, then a check is made in step 760 of whether or not all possible swaps are explored. If there are remaining swaps to be explored, then processing returns to step 730, as described above, to explore another one of these swaps in the same manner. Otherwise, having explored as possible swaps, the new alignment and its associated score are output as the current values of new_alignment and best_score in step 770. The new alignment acts as the generator alignment for the next iteration of the method of FIG. 5.

### 5. Computer Hardware

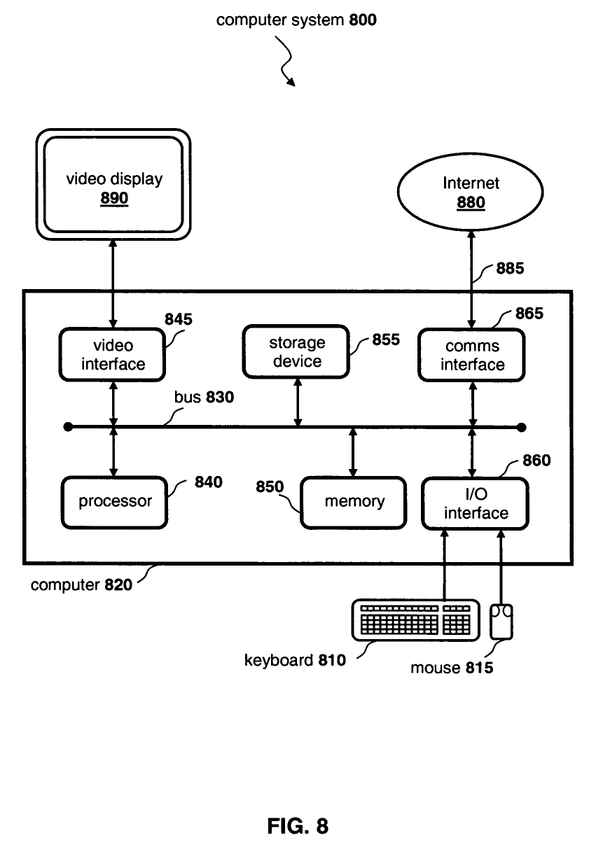

FIG. 8 is a schematic representation of a computer system 800 suitable for executing computer software programs. Computer software programs execute under a suitable operating system installed on the computer system 800, and may be thought of as a collection of software instructions for implementing particular steps.

The components of the computer system 800 include a computer 820, a keyboard 810 and mouse 815, and a video display 890. The computer 820 includes a processor 840, a memory 850, input/output (I/O) interface 860, communications interface 865, a video interface 845, and a storage device 855. All of these components are operatively coupled by a system bus 830 to allow particular components of the computer 820 to communicate with each other via the system bus 830.

The processor 840 is a central processing unit (CPU) that executes the operating system and the computer software program executing under the operating system. The memory 850 includes random access memory (RAM) and read-only memory (ROM), and is used under direction of the processor 840.

The video interface 845 is connected to video display 890 and provides video signals for display on the video display 890. User input to operate the computer 820 is provided from the keyboard 810 and mouse 815. The storage device 855 can include a disk drive or any other suitable storage medium.

The computer system 800 can be connected to one or more other similar computers via a communications interface 865 using a communication channel 885 to a network, represented as the Internet 880.

The computer software program may be recorded on a storage medium, such as the storage device 855. Alternatively, the computer software can be accessed directly from the Internet 880 by the computer 820. In either case, a user can interact with the computer system 800 using the keyboard 810 and mouse 815 to operate the computer software program executing on the computer 820. During operation, the software instructions of the computer software program are loaded to the memory 850 for execution by the processor 840.

Other configurations or types of computer systems can be equally well used to execute computer software that assists in implementing the techniques described herein.

### 6 Experiments

6.1 Experimental Setup

The results of several experiments are present. There experiments are designed to study the following:

1. Effectiveness of the pruning techniques.

2. Effect of caching on the performance.

3. Effectiveness of the alignment transformation operations.

4. Effectiveness of the iterative search scheme.

Fixed Alignment Decoding is used as the baseline algorithm in the experiments. To compare the performance of our algorithm with a state-of-the-art decoding algorithm, the Greedy decoder is used as available from http://www.isi.edu/licensed-sw/rewrite-decoder. In the empirical results from the experiments, in place of the translation score, the logscore (i.e. negative logarithm) of the translation score is used. When reporting scores for a set of sentences, the geometric mean of their translation scores is treated as the statistic of importance and the average logscore reported.

6.1.1 Training of the Models

A French-English translation model (IBM-4) is built by training over a corpus of 100 K sentence pairs from the Hansard corpus. The translation model is built using the GIZA++ toolkit. Further details can be obtained from http://www-i6.informatik.rwth-aachen.de/Colleagues/och/software/GIZA++.html and Och and Ney, “Improved statistical alignment methods”, ACL00, pages 440-447, Hongkong, China, 2000. The content of both these references is incorporated herein in their entirety. There were 80 word classes which were determined using the mkcls tool. Further details can be obtained from http://www-i6.informatik.rwth-aachen.de/Colleagues/och/software/mkcls.html. The content of this reference is incorporated herein in its entirety. An English trigram language model is built by training over a corpus of 100 K English sentences. The CMU-Cambridge Statistical Language Modeling Tool Kit v2 is used for training the language model. This is developed by R. Rosenfeld and P. Clarkson, and is available from http://mi.eni.cam.ac.uk/˜prc14/toolkit documentation.html. While training the translation and language models, the default setting of the corresponding tools is used. The corpora used for training the models were tokenized using an in-house Tokenizer.

6.1.2 Test Data

The data used in the experiments consisted of 11 sets of 100 French sentences picked randomly from the French part of the Hansard corpus. The sets are formed based on the number of words in the sentences. There are 11 sets of sentences selected, whose length is in the range 6-10; 11-15, . . . , 56-60.

6.2 Decoder Implementation

The algorithm is implemented in C++ and compiled it using gcc with —O3 optimization setting. Methods which had less than 15 lines of code are inlined.

6.2.1 System

The experiments are conducted on an Intel Dual Processor machine (2.6 GHz CPU, 2 GB RAM) with Linux as the OS, with no other job running.

6.3 Starting Generator Alignment

The algorithm requires a starting alignment to serve as the generator for the family of alignments. The alignment aⱼ=j, i.e., l=m and a=(1, . . . ,m) is used as the starting alignment. This particular alignment is a natural choice for French and English as their word orders are closely related.

6.4 Effect of Pruning

The following measures are indicative of the effectiveness of pruning:

1. Percentage of partial hypotheses retained by the pruning technique at each phase of the dynamic programming algorithm.

2. Time taken by the algorithm for decoding.

3. Loigscores of the translations.

6.4.1 Pruning with the Geometric Mean (PGM)

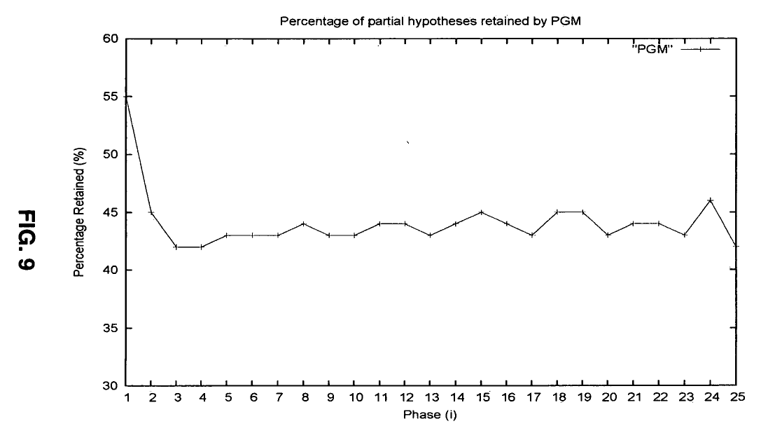

FIG. 9 shows the percentage of partial hypotheses retained at each phase of the dynamic programming algorithm for a set of 100 French sentences of length 25 when the geometric mean of the scores was used for pruning. With this pruning technique, the algorithm removes more than half (about 55% of the partial hypotheses at each phase).

6.4.2 Generator Guided Pruning (GGP)

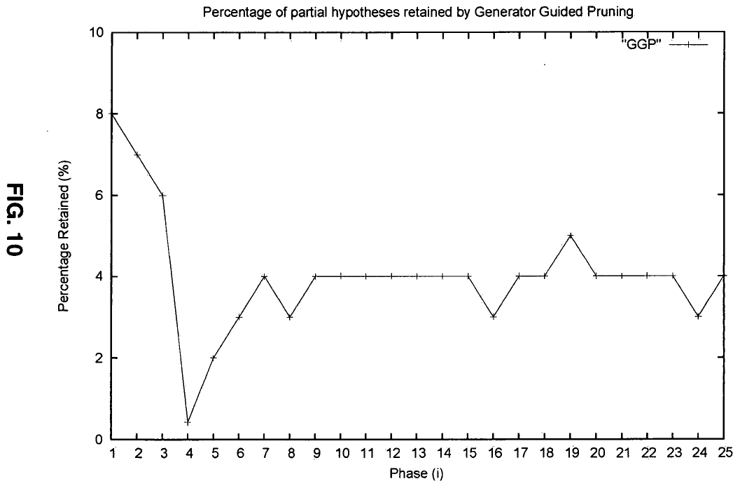

FIG. 10 shows the percentage of partial hypotheses retained at each phase of the dynamic programming algorithm for a set of 100 French sentences of length 25 by the Generator Guided Pruning technique. This pruning technique is very conservative and retains only a small fraction of the partial hypotheses at each phase. All the partial hypotheses that survive in a phase are guaranteed to have scores at least as good as the score of the partial hypothesis corresponding to the Fixed Alignment Decoding solution. On an average, only 5% of the partial hypotheses move to the next phase.

6.4.3 Performance

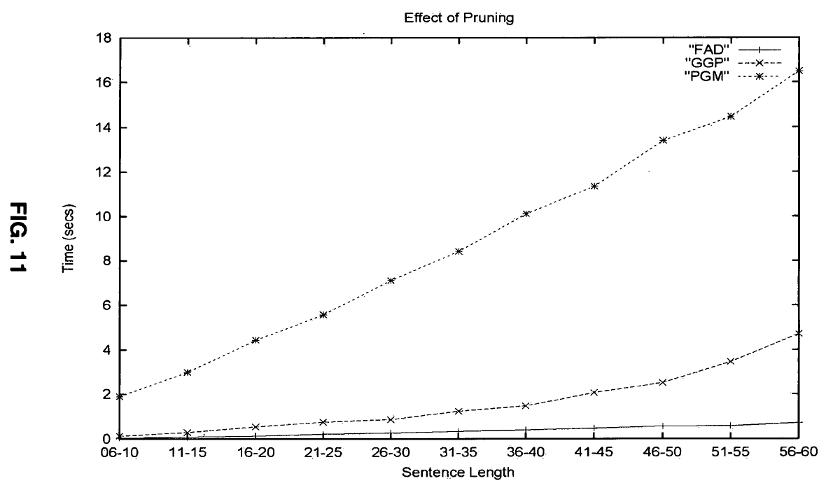

FIG. 11 shows the time taken by the dynamic programming algorithm with each of the pruning techniques. As hinted by the statistics shown in FIGS. 10 and 9, the Generator Guided Pruning technique speeds up the algorithm much more than pruning with the geoemtric mean.

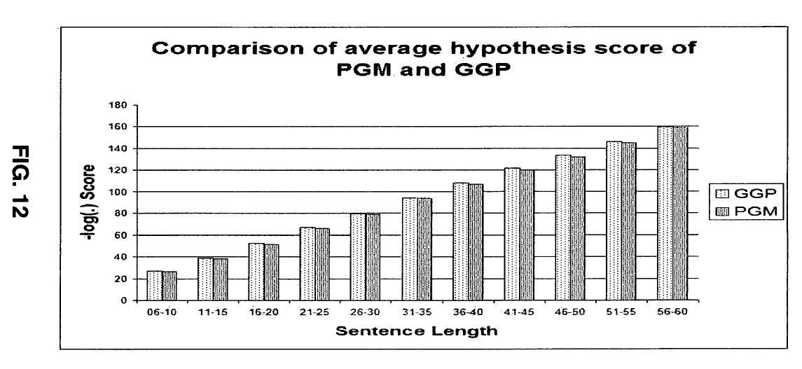

FIG. 12 shows the logscores of the translations found by the algorithm with each of the pruning techniques. Pruning with the Geometric Mean fares better than Generator Guided Pruning, but the difference is not significant.

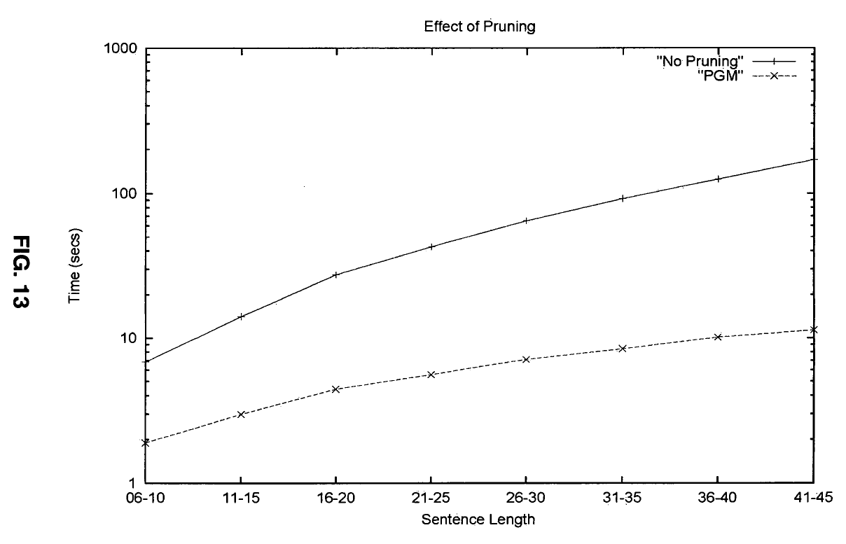

The logscores of the translations found by PGM are compared with those of the translations found by the dynamic programming algorithm without pruning and found that the logscores were identical. This means that our pruning techniques are very effective in identifying and removing inconsequential partial hypotheses. FIG. 13 shows the time taken by the decoding algorithm when there is no pruning.

From FIGS. 11 and 12, Generator Guided Pruning is a very effective pruning technique.

6.5 Effect of Caching

In caching, the number of cache hits is a measure of the repeated use of the cached data. Also of interest is the improvement in runtime due to caching.

6.5.1 Language Model Caching

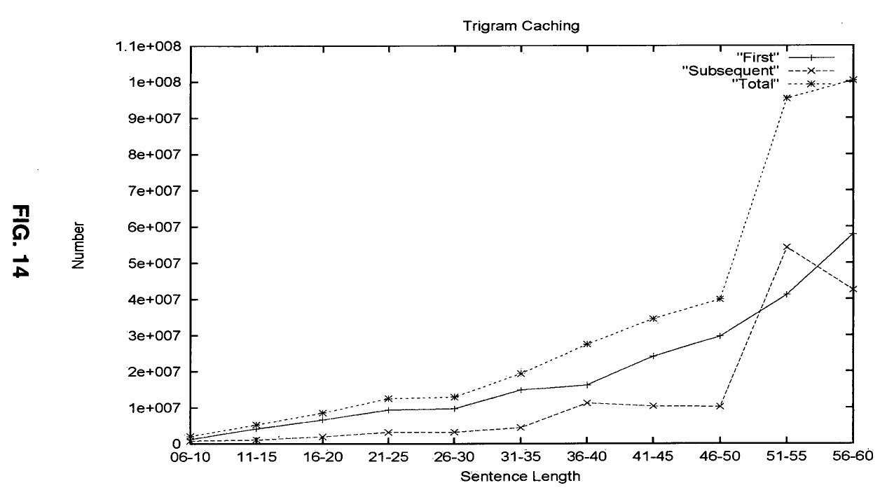

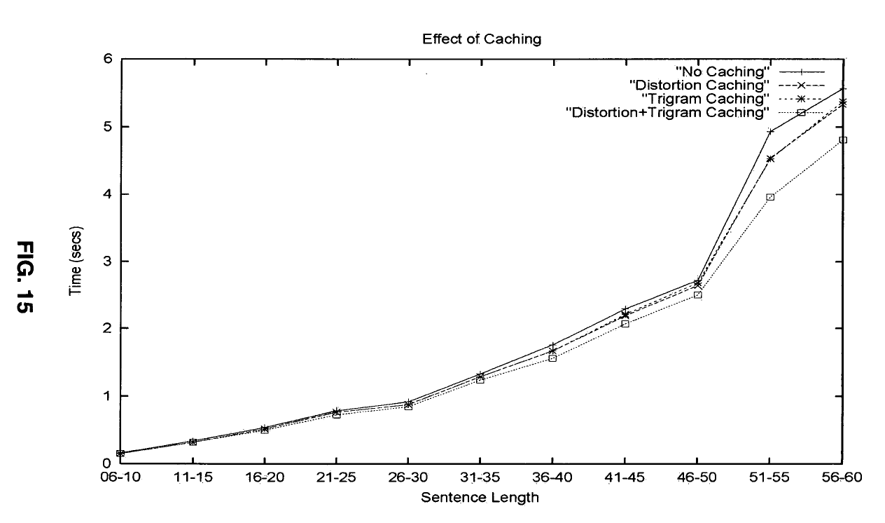

FIG. 14 shows the number of distinct trigrams accessed by the algorithm and the number of subsequent accesses to the cached values of these trigrams. On an average every second trigram is accessed at least once more. FIG. 15 shows the time taken for decoding when only the language model is cached. Caching of language model has little effect on smaller length sentences. But as the sentence length grows, caching of language model improves the speed.

6.5.2 Distortion Model Caching

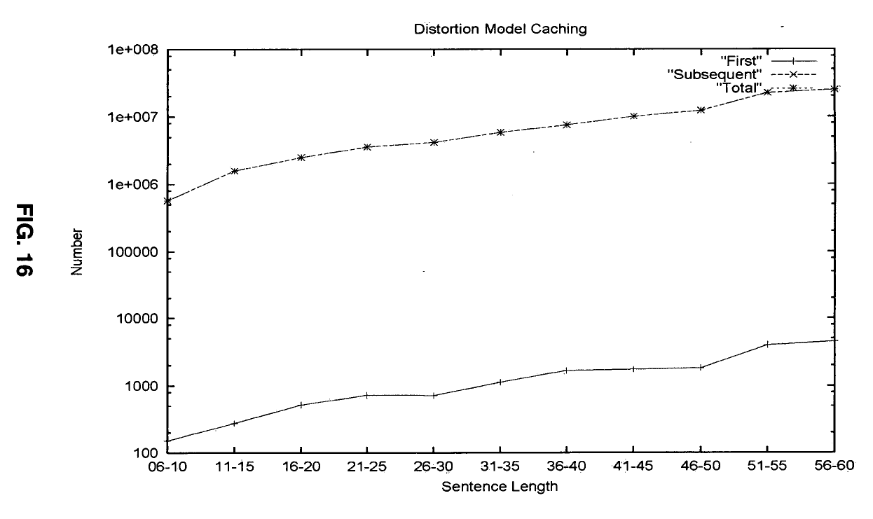

FIG. 16 shows the counts of first hits and subsequent hits for distortion model values accessed by the algorithm. 99:97% of the total number of accesses are to the cached values. Thus, cached distortion model values are used repeatedly by the algorithm. FIG. 15 shows the time taken for decoding when only the distortion model is cached. Improvement in speed is more significant for longer sentences than for shorter sentences as expected.

FIG. 15 shows the time taken for decoding when both the models are cached. As can be observed from the plots, caching of both the models is more beneficial than caching them individually. Although the improvement in speed due to caching is not substantial in our implementation, our experiments do show that cached values are accessed subsequently. It should be possible to speed up the algorithm further by using better data structures for the cached data.

6.6 Alignment Transformation Operations

To understand the effect of the alignment transformation operations on the performance of the algorithm, experiments are conducted in which each of GROW, MERGE and SHRINK operations are removed, and with the decoder using Generator Guided Pruning.

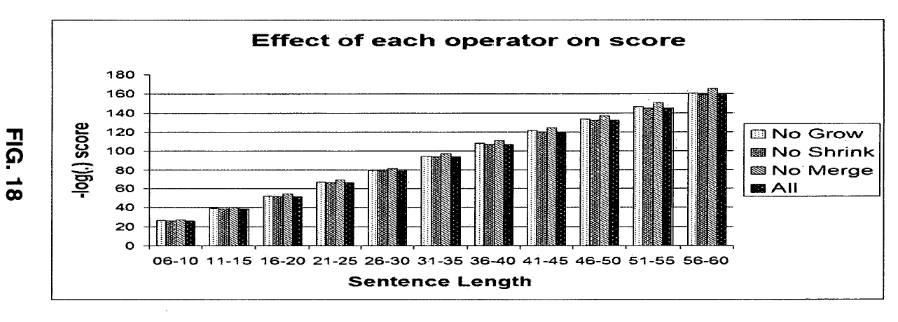

FIG. 18 shows the logscores when the decoder worked with only (GROW, MERGE, COPY) operations, (SHRINK, MERGE, COPY) operations and (GROW, SHRINK, COPY) operations. The logscores are compared with those of the decoder which worked with all the four operations. The logscores are affected very little by the absence of SHRINK operation. However, the absence of MERGE operation results in poorer scores. The absence of GROW operation also results in poorer scores but the loss is not as significant as with MERGE.

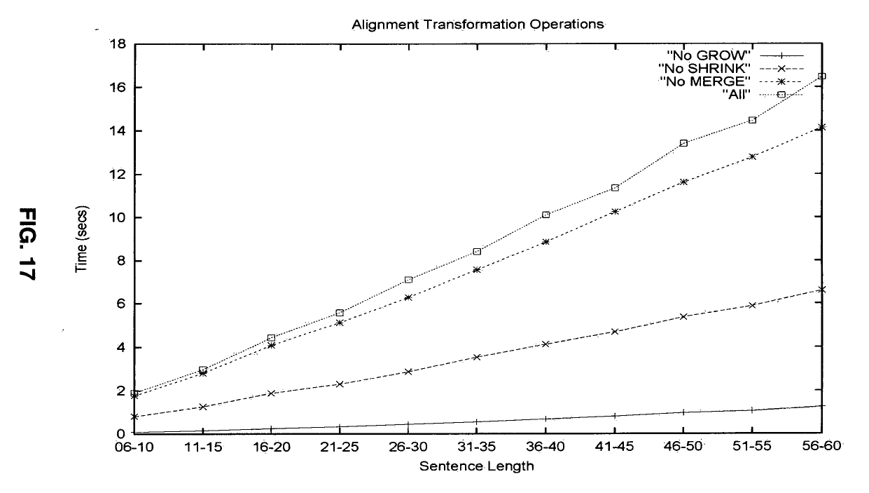

FIG. 17 shows the time taken for decoding in this experiment. The absence of MERGE does not affect the time taken for decoding significantly. The absence of either GROW or SHRINK has significant affect on the time taken for decoding. This is not unexpected as GROW operations add the highest number of partial hypotheses at each phase of the algorithm 3.3.1. Although a SHRINK operation adds only one new partial hypothesis, its contribution to the number of distinct hypothesis classes is significant.

The MERGE operation while not contributing significantly to the runtime of the algorithm plays a role in improving the scores.

6.7 Iterative Search

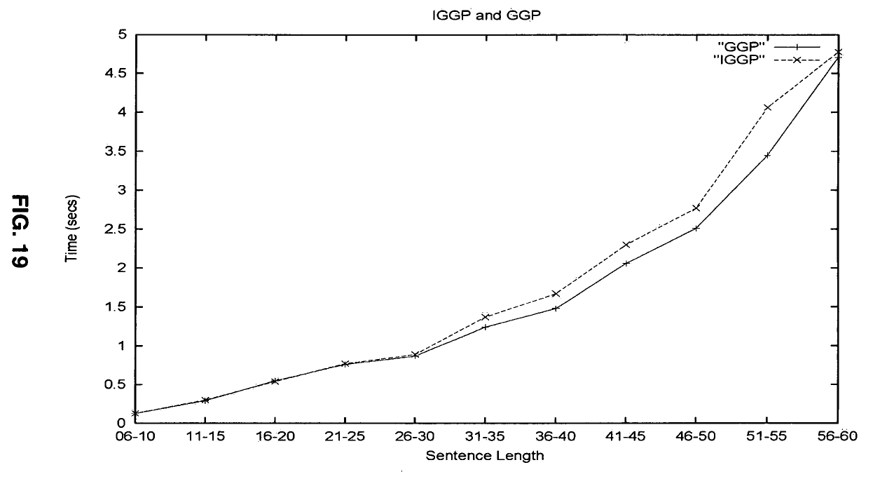

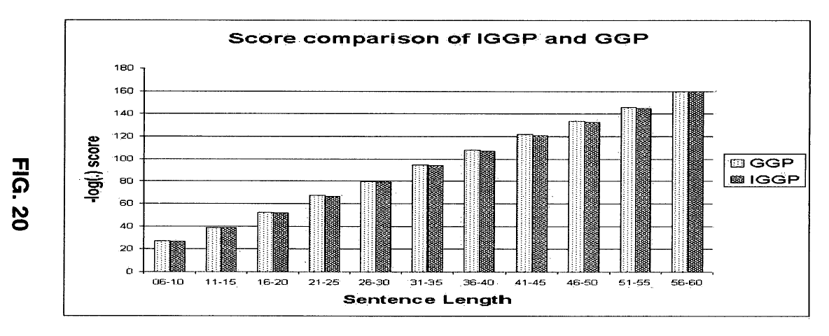

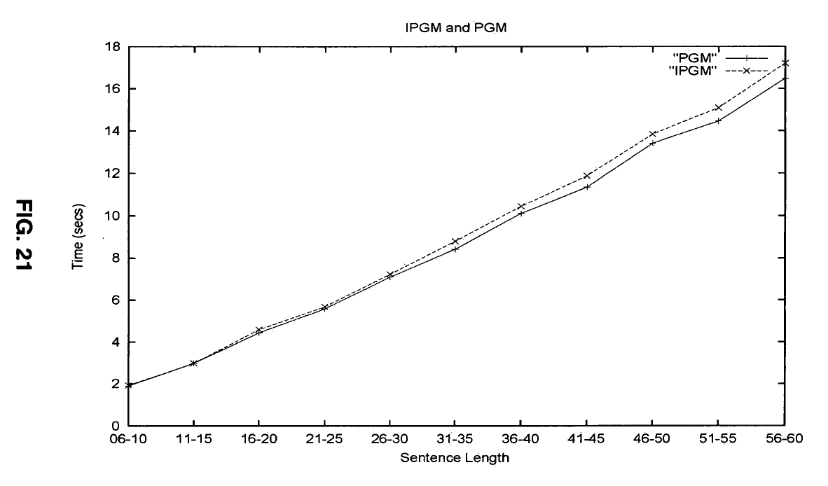

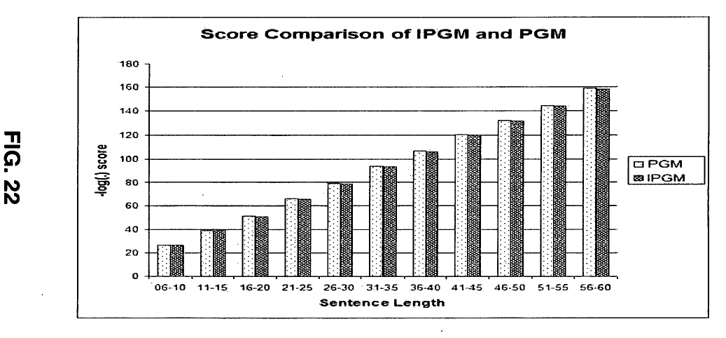

FIGS. 19 and 21 show the time taken by the iterative search algorithm with Generator Guided Pruning (IGGP) and pruning with Geometric Mean (IPGM). FIGS. 20 and 22 show the corresponding logscores. The improvement in logscores due to iterative search is not significant.

6.8 Comparison with the Greedy Decoder

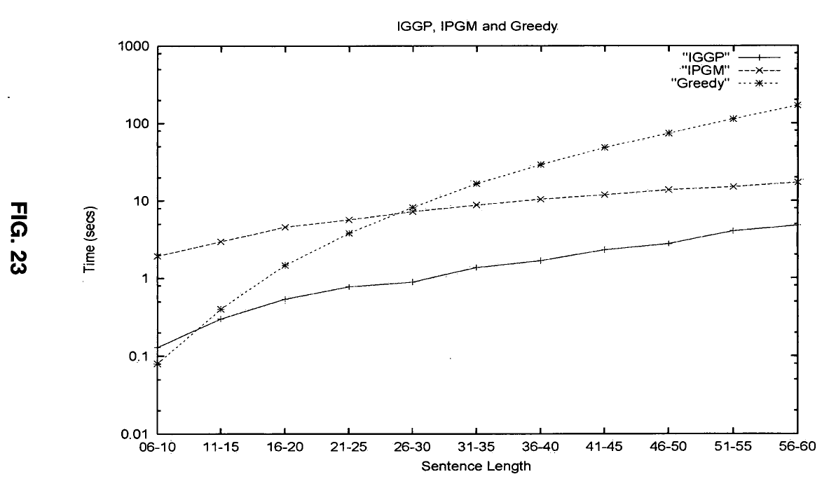

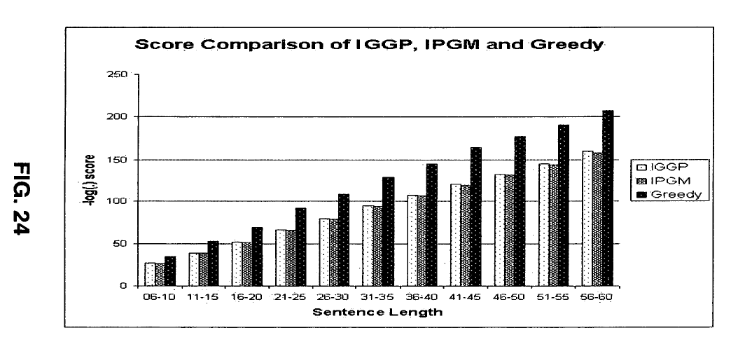

The performance of the algorithm is compared with that of the Greedy decoder. FIG. 23 compares the time taken for decoding by the algorithm described herein and the Greedy decoder. FIG. 24 shows the corresponding logscores. The iterated search algorithm that prunes with the Geometric Mean (IPGM) is faster than the Greedy decoder for sentences whose length is greater than 25. However, the iterated search algorithm that uses Generator Guided Pruning technique (IGGP) is faster than the Greedy decoder for sentences whose length is greater than 10. As can be noted from the plots, IGGP is at least 10 times faster than the greedy algorithm for most sentence lengths. Logscores are better than those of the greedy decoder with either of the pruning techniques (FIG. 24).

### 7. Conclusion

A suitable decoding algorithm is key to a statistical machine translation system in terms of speed and accuracy. Decoding is in essence an optimization procedure in finding a target sentence. While every problem instance has an “optimal” target sentence, finding that target sentence given time/computational constraints is a central challenge for such systems. Since the space of possible translations is large, typically decoding algorithms that examine a portion of that space risk overlooking satisfactory solutions. Various alterations and modifications can be made to the techniques and arrangements described herein, as would be apparent to one skilled in the relevant art.

1. A method for translating words of a source text in a source language into words of a target text in a target language, the method comprising:
determining a hypothesis for a translation of the a given source language sentence by:
building, using transformation operators, a family of alignments from a generator alignment, wherein each alignment maps words in source text and words in a corresponding target hypothesis in the target language;
extending each said target hypothesis into a family of extended target hypotheses by supplementing the target hypothesis with a predetermined number of words selected from a vocabulary of words in the target language, wherein each of said transformation operators has an associated number of words; and
determining a first alignment and the hypothesis from the family of extended target hypotheses, based on a first score associated with each extended target hypothesis;
(b) finding a second alignment by:
generating for the first alignment a set of modified alignments; and
selecting the second alignment from the modified alignments, wherein the second alignment has an associated score that improves on said first score; and
selecting the hypothesis as the target text following iterations of said determining of said hypothesis and said finding of said second alignment.

2. The method as claimed in claim 1, wherein the transformation operators comprise at least one of a COPY operator, a MERGE operator, a SHRINK operator and a GROW operator.

3. The method as claimed in claim 2, wherein a number of words associated with the MERGE operator and the SHRINK operator is zero words, the number of words associated with the COPY operator is one word, and the number of words associated with the GROW operator is two words.

4. The method as claimed in claim 1, wherein said building and extending are repeated in a number of phases dependent on a length of the source text.

5. The method as claimed in claim 1, wherein said extending of each of the target hypotheses comprises computing an associated score for each extended target hypothesis based upon a language model score and a translation model score.

6. The method as claimed in claim 4, further comprising, in each phase, classifying the extended target hypotheses into classes and retaining a subset of hypotheses in each class for processing in subsequent phases, wherein said retaining is based upon scores associated with each hypothesis.

7. The method as claimed in claim 6, wherein the classes comprise at least one of:
a class of hypotheses having the same last two words in a partial translation;
a class of hypotheses having a same fertility of the last word in the partial translation; and
a class of hypotheses having a same central word in a tablet of the last word in the partial translation.

8. The method as claimed in claim 1, further comprising pruning the extended target hypotheses by discarding extended target hypotheses having an associated score that is less than a geometric mean of the family of extended target hypotheses.

9. The method as claimed in claim 4, further comprising pruning, in each phase, the extended target hypotheses by discarding extended target hypotheses having an associated score that is less than the score associated with the generator hypothesis for a current phase.

10. The method according to claim 1, wherein each alignment has an associated set of tablets and the set of modified alignments is generated by swapping the tablets associated with the first alignment.

11. The method according to claim 10, wherein a second score is determined for each of the set of modified alignments and said selecting selects a modified alignment having a highest score.

12. The method as claimed in claim 1, wherein the family of alignments comprises an exponential number of alignments.

13. The method as claimed in claim 1, wherein said building of said family of alignments comprises using a Viterbi alignment technique.

14. The method as claimed in claim 1, wherein said determining of said first alignment and said hypothesis comprises using a dynamic programming.

15. A computer program product comprising:
a storage medium readable by a computer system and recording software instructions executable by a the computer system for implementing a method of:
determining a hypothesis for a translation of a given source language sentence by performing the steps of:
building, using transformation operators, a family of alignments from a generator alignment, wherein each alignment maps words in the source text and words in a corresponding target hypothesis in the target language;
extending each said target hypothesis into a family of extended target hypotheses by supplementing the target hypothesis with a predetermined number of words selected from a vocabulary of words in the target language, wherein each of said transformation operators has an associated number of words; and
determining a first alignment and the hypothesis from the family of extended target hypotheses, based on a first score associated with each extended target hypothesis;
finding a second alignment by:
generating for the first alignment a set of modified alignments; and
selecting the second alignment from the modified alignments, wherein the second alignment has an associated score that improves on said first score; and
selecting the hypothesis as the target text following iterations of said determining of said hypothesis and said finding of said second alignment.

16. A computer system comprising:
a processor for executing software instructions;
a memory for storing said software instructions;
a system bus coupling the memory and the processor; and
a storage medium recording said software instructions that are loadable to the memory for implementing a method of:
determining a hypothesis for a translation of a given source language sentence by:
building, using transformation operators, a family of alignments from a generator alignment, wherein each alignment maps words in the source text and words in a corresponding target hypothesis in the target language;
extending each said target hypothesis into a family of extended target hypotheses by supplementing the target hypothesis with a predetermined number of words selected from a vocabulary of words in the target language, wherein each of said transformation operators has an associated number of words; and
determining a first alignment and the hypothesis from the family of extended target hypotheses, based on a first score associated with each extended target hypothesis;
finding a second alignment by:
generating for the first alignment a set of modified alignments; and
selecting the second alignment from the modified alignments, wherein the second alignment has an associated score that improves on said first score; and
selecting the hypothesis as the target text following iterations of said determining of said hypothesis and said finding of said second alignment.

17. The computer system as claimed in claim 16, wherein the transformation operators comprise at least one of a COPY operator, a MERGE operator, a SHRINK operator and a GROW operator.

18. The computer system as claimed in claim 17, wherein a number of words associated with the MERGE operator and the SHRINK operator is zero words, the number of words associated with the COPY operator is one word, and the number of words associated with the GROW operator is two words.

19. The computer system as claimed in claim 16 wherein said building and extending are repeated in a number of phases dependent on a length of the source text.

20. The computer system as claimed in claim 16, wherein said extending of each of the target hypotheses comprises computing an associated score for each extended target hypothesis based upon a language model score and a translation model score.
